(19) United States
(12) Patent Application Publication
(10) Pub. No.: US 2020/0005553 A1
(43) Pub. Date: Jan. 2, 2020

(54) DEVIATION ASSESSMENT FOR STEERING SYSTEM

(71) Applicant: Ford Global Technologies, LLC, Dearborn, MI (US)

(72) Inventors: Devon Eyerman, Plymouth, MI (US); Dexin Wang, Livonia, MI (US); Joshua Guerra, Farmington Hills, MI (US); Lodewijk Wijffels, Canton, MI (US); Jens Christiansen, Plymouth, MI (US)

(73) Assignee: Ford Global Technologies, LLC, Dearborn, MI (US)

(21) Appl. No.: 16/023,828

(22) Filed: Jun. 29, 2018

(51) Int. Cl. G07C 5/00; B62D 5/04; G07C 5/08

(52) U.S. Cl. CPC G07C 5/006; G07C 5/0808; G07C 5/0816; B62D 5/0481

(57) ABSTRACT

A computer includes a processor and a memory storing processor-executable instructions. The processor is programmed to determine a deviation between a predicted value and one of a sensed steering angle and a sensed steering torque of a vehicle, output a service request in response to the deviation exceeding a first threshold, and perform a minimal risk condition in response to the deviation exceeding a second threshold.

### BACKGROUND

Vehicle chassis can experience various types of performance degradation. Steering pull occurs when the vehicle's steering tends to turn to one side while driving on a straightaway at a constant speed, requiring additional torque to counteract the drift. Steering nibble is an identifiable vibration characterized by a slight or partial oscillation of the road wheels leading to an oscillation in the steering system. Clear vision offset occurs when the center position of the steering wheel does not correspond to straight-ahead driving. Steering delay is a lag time between an input to the steering wheel and the output of turning the road wheels. Thrust angle misalignment occurs when the direction of the front wheels (when centered) or the rear wheels is not parallel to the centerline of the vehicle.

### BRIEF DESCRIPTION OF THE DRAWINGS

FIG. 1 is a block diagram of an example vehicle.

FIG. 2 is a diagram of an example steering system of the vehicle of FIG. 1.

FIG. 3 is a process flow diagram of an example process for steering the vehicle of FIG. 1.

FIG. 4 is a process flow diagram of an example process for addressing deviations in steering the vehicle.

### DETAILED DESCRIPTION

A steering system and computer as described herein can analyze the performance of a vehicle and can act based on the severity of degradation of the performance. The analysis of the performance can be more accurate and/or reliable than could be provided by a human occupant. Moreover, the vehicle can take the appropriate action based on the severity of the degradation, such as requesting service or, in the case of autonomous operation, pulling the vehicle over.

A computer includes a processor and a memory storing processor-executable instructions, and the processor is programmed to determine a deviation between a predicted value and one of a sensed steering angle and a sensed steering torque of a vehicle, output a service request in response to the deviation exceeding a first threshold, and perform a minimal risk condition in response to the deviation exceeding a second threshold.

The predicted value may be a requested steering angle. The deviation may be one of a difference between the requested steering angle and the sensed steering angle, a delay between the requested steering angle and the sensed steering angle, a difference between a frequency of the requested steering angle and of the sensed steering angle, and a difference between an amplitude of the requested steering angle and of the sensed steering angle. The sensed steering angle may be a sensed position of a physical component of a steering system of the vehicle.

The processor may be further programmed to instruct a steering system to turn the vehicle by the requested steering angle.

The predicted value may be a compensated steering angle, and the deviation may be a thrust angle. The processor may be further programmed to determine the compensated steering angle based on wheel speeds of the vehicle.

The predicted value may be a predicted steering torque, and the deviation may be a difference between the predicted steering torque and the sensed steering torque. The processor may be further programmed to calculate the predicted steering torque as an average for an interval of driving based on a position of the vehicle over the interval. Calculating the predicted steering torque may also be based on road conditions over the interval.

A method includes determining a deviation between a predicted value and one of a sensed steering angle and a sensed steering torque of a vehicle, outputting a service request in response to the deviation exceeding a first threshold, and performing a minimal risk condition in response to the deviation exceeding a second threshold.

The predicted value may be a requested steering angle. The deviation may be one of a difference between the requested steering angle and the sensed steering angle, a delay between the requested steering angle and the sensed steering angle, a difference between a frequency of the requested steering angle and of the sensed steering angle, and a difference between an amplitude of the requested steering angle and of the sensed steering angle. The sensed steering angle may be a sensed position of a physical component of a steering system of the vehicle.

The method may further include instructing a steering system to turn the vehicle by the requested steering angle.

The predicted value may be a compensated steering angle, and the deviation may be a thrust angle. The method may further include determining the compensated steering angle based on wheel speeds of the vehicle.

The predicted value may be a predicted steering torque, and the deviation may be a difference between the predicted steering torque and the sensed steering torque. The method may further include calculating the predicted steering torque as an average for an interval of driving based on a position of the vehicle over the interval. Calculating the predicted steering torque may also be based on road conditions over the interval.

A computer 30 includes a processor and a memory storing processor-executable instructions. The processor is programmed to determine a deviation between a predicted value and one of a sensed steering angle and a sensed steering torque of a vehicle 32, output a service request in response to the deviation exceeding a first threshold, and perform a minimal risk condition in response to the deviation exceeding a second threshold.

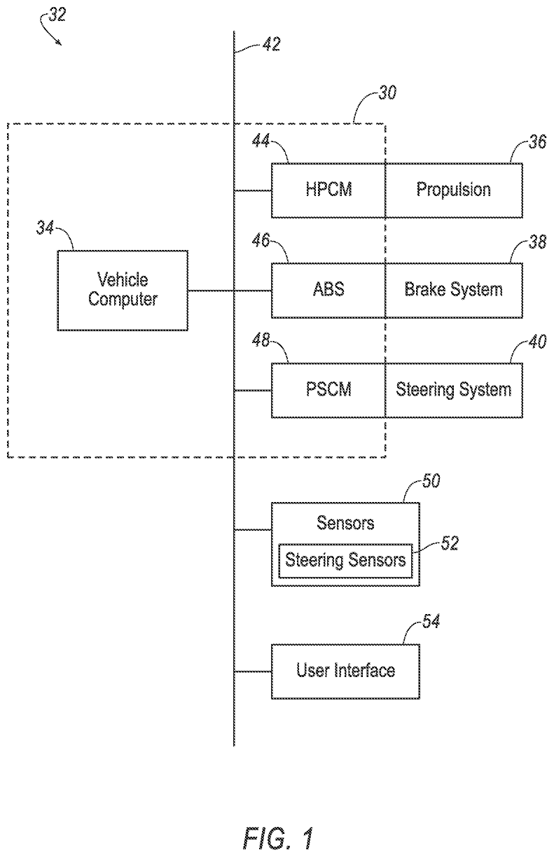

With reference to FIG. 1, the vehicle 32 may be an autonomous or semi-autonomous vehicle. A vehicle computer 34 can be programmed to operate the vehicle 32 independently of the intervention of a human driver, completely or to a lesser degree. The vehicle computer 34 may be programmed to operate a propulsion 36, brake system 38, steering system 40, and/or other vehicle systems. For the purposes of this disclosure, autonomous operation means the vehicle computer 34 controls the propulsion 36, brake system 38, and steering system 40 without input from a human driver; semi-autonomous operation means the vehicle computer 34 controls one or two of the propulsion 36, brake system 38, and steering system 40 and a human driver controls the remainder, or that the vehicle computer 34 controls the propulsion 36, brake system 38, and steering system 40 without input from a human driver in predefined contexts and not outside those contexts; and nonautonomous operation means a human driver controls the propulsion 36, brake system 38, and steering system 40.

The vehicle computer 34 is a microprocessor-based computer. The vehicle computer 34 includes a processor, memory, etc. The memory of the vehicle computer 34 includes memory for storing instructions executable by the processor as well as for electronically storing data and/or databases.

The computer 30 is one or more microprocessor-based computers. The computer 30 includes memory, at least one processor, etc. The memory of the computer 30 includes memory for storing instructions executable by the processor as well as for electronically storing data and/or databases. The computer 30 may be the same computer as the vehicle computer 34, or the computer 30 may be one or more separate computers in communication with the vehicle computer 34 via a communications network 42, or the computer 30 may encompass multiple computers including the vehicle computer 34. As a separate computer, the computer 30 may be or include, e.g., one or more electronic control units or modules (ECU or ECM) such as a hybrid-powertrain control module 44, an antilock brake control module 46, and/or a power-steering control module 48.

The computer 30 may transmit and receive data through the communications network 42, which may be a controller area network (CAN) bus, Ethernet, WiFi, Local Interconnect Network (LIN), onboard diagnostics connector (OBD-II), and/or by any other wired or wireless communications network. The computer 30 may be communicatively coupled to the vehicle computer 34, the other ECMs 44, 46, 48, the propulsion 36, the brake system 38, the steering system 40, sensors 50 including steering sensors 52, a user interface 54, and other components via the communications network 42.

The propulsion 36 of the vehicle 32 generates energy and translates the energy into motion of the vehicle 32. The propulsion 36 may be a known vehicle propulsion subsystem, for example, a conventional powertrain including an internal-combustion engine coupled to a transmission that transfers rotational motion to road wheels 56; an electric powertrain including batteries, an electric motor, and a transmission that transfers rotational motion to the road wheels 56; a hybrid powertrain including elements of the conventional powertrain and the electric powertrain; or any other type of propulsion. The propulsion 36 can include an electronic control unit (ECU) or the like that is in communication with and receives input from the vehicle computer 34 and/or a human driver, e.g., the hybrid-powertrain control module 44. The human driver may control the propulsion 36 via, e.g., an accelerator pedal and/or a gear-shift lever.

The brake system 38 is typically a known vehicle braking subsystem and resists the motion of the vehicle 32 to thereby slow and/or stop the vehicle 32. The brake system 38 may include friction brakes such as disc brakes, drum brakes, band brakes, etc.; regenerative brakes; any other suitable type of brakes; or a combination. The brake system 38 can include an electronic control unit (ECU) or the like that is in communication with and receives input from the vehicle computer 34 and/or a human driver, e.g., the antilock brake control module 46. The human driver may control the brake system 38 via, e.g., a brake pedal.

The steering system 40 is typically a known vehicle steering subsystem and controls the turning of the road wheels 56. The steering system 40 may be a rack-and-pinion system with electric power-assisted steering, a steer-by-wire system, as both are known, or any other suitable system. The steering system 40 can include an electronic control unit (ECU) or the like that is in communication with and receives input from the vehicle computer 34 and/or a human driver, e.g., the power-steering control module 48. The human driver may control the steering system 40 via, e.g., a steering wheel 58, handheld remote control (not shown), etc.

The sensors 50 provide data for autonomous operation of the vehicle 32. The sensors 50 may provide data about operation of the vehicle 32, for example, engine and transmission data such as temperature, fuel consumption, etc.; the steering sensors 52 (described below); etc. The sensors 50 may detect the location and/or orientation of the vehicle 32. For example, the sensors may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 50 may detect the external world, e.g., objects and/or characteristics of surroundings of the vehicle 32, such as other vehicles, road lane markings, traffic lights and/or signs, pedestrians, etc. For example, the sensors 50 may include radar sensors, scanning laser range finders, light detection and ranging (LIDAR) devices, and image processing sensors such as cameras. The sensors 50 may include communications devices, for example, vehicle-to-infrastructure (V2I) or vehicle-to-vehicle (V2V) devices.

The user interface 54 presents information to and receives information from an occupant of the vehicle 32. The user interface 54 may be located, e.g., on an instrument panel in a passenger cabin of the vehicle 32, or wherever may be readily seen by the occupant. The user interface 54 may include dials, digital readouts, screens, speakers, and so on for providing information to the occupant, e.g., human-machine interface (HMI) elements such as are known. The user interface 54 may include buttons, knobs, keypads, microphones, and so on for receiving information from the occupant.

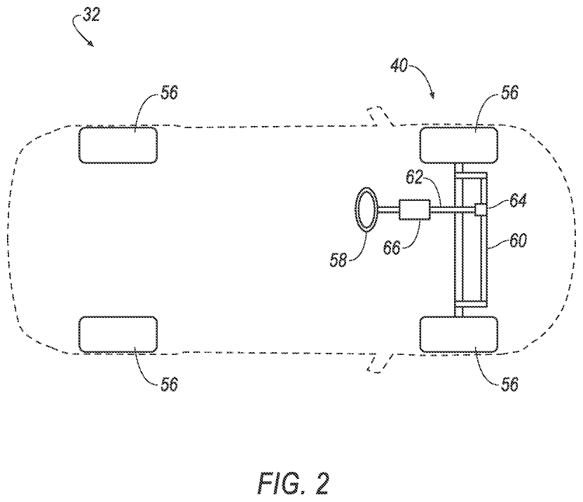

With reference to FIG. 2, the steering system 40 may be a conventional rack-and-pinion steering system. Alternatively or additionally, the steering system 40 may be a Pitman-arm system, a rear-steer system, etc. (not shown). A steering rack 60 may be turnably coupled to the road wheels 56, for example, in a four-bar linkage. The position of the steering rack 60 determines the turning of the road wheels 56. Translational motion of the steering rack 60 results in turning of the road wheels 56. A steering column 62 may be coupled to the steering rack 60 via a rack and pinion 64, that is, gear meshing between a pinion gear and a rack gear (not shown).

The steering column 62 transfers rotation of the steering wheel 58 to movement of the steering rack 60. The steering column 62 may be, e.g., a shaft connecting the steering wheel 58 to the steering rack 60. The steering column 62 may house a clutch and one or more of the steering sensors 52 such as a torque sensor (not shown).

The steering wheel 58 allows an operator to steer the vehicle 32 by transmitting rotation of the steering wheel 58 to movement of the steering rack 60. The steering wheel 58 may be, e.g., a rigid ring fixedly attached to the steering column 62 such as is known.

A steering actuator 66 is coupled to the steering system 40, e.g., the steering column 62, so as to cause turning of the road wheels 56. For example, the steering actuator 66 may be an electric motor rotatably coupled to the steering column 62, that is, coupled so as to be able to apply a steering torque to the steering column 62. The steering actuator 66 may provide power assist to the steering system 40. In other words, the steering actuator 66 may provide torque in a direction in which the steering wheel 58 is being rotated by a human driver, allowing the driver to turn the steering wheel 58 with less effort. The steering actuator 66 may be an electric power-assisted steering actuator.

Alternatively to the rack-and-pinion steering system, the steering system 40 may be a steer-by-wire steering system, i.e., may have a gap in mechanical linkages between the steering wheel 58 and the road wheels 56. If the vehicle 32 is a fully autonomous vehicle, the steering system 40 may be a steer-by-wire steering system lacking the steering wheel 58 and the steering column 62. The computer 30, e.g., the power-steering control module 48, may receive signals from the steering sensors 52, e.g., a position sensor positioned to detect the orientation of the steering wheel 58, or from the vehicle computer 34. The position sensor may be, e.g., a Hall effect sensor, a rotary encoder, etc. The computer 30 may output a signal to the steering actuator 66. The steering actuator 66 may be one or more electromechanical actuators coupled to the steering rack 60 in lieu of the rack and pinion 64, and the steering actuator 66 may transform the signal into mechanical motion of the steering rack 60.

Returning to FIG. 1, the steering sensors 52 provide data about components of the steering system 40. For example, the steering sensors 52 include wheel-speed sensors for the road wheels 56; position sensors on components of the steering system 40 such as the steering wheel 58, the steering column 62, the rack and pinion 64, or the steering rack 60; and torque sensors on components of the steering system 40 such as the steering column 62, the rack and pinion 64, or the steering actuator 66. The position sensors may include, e.g., individual steering knuckle angle sensors.

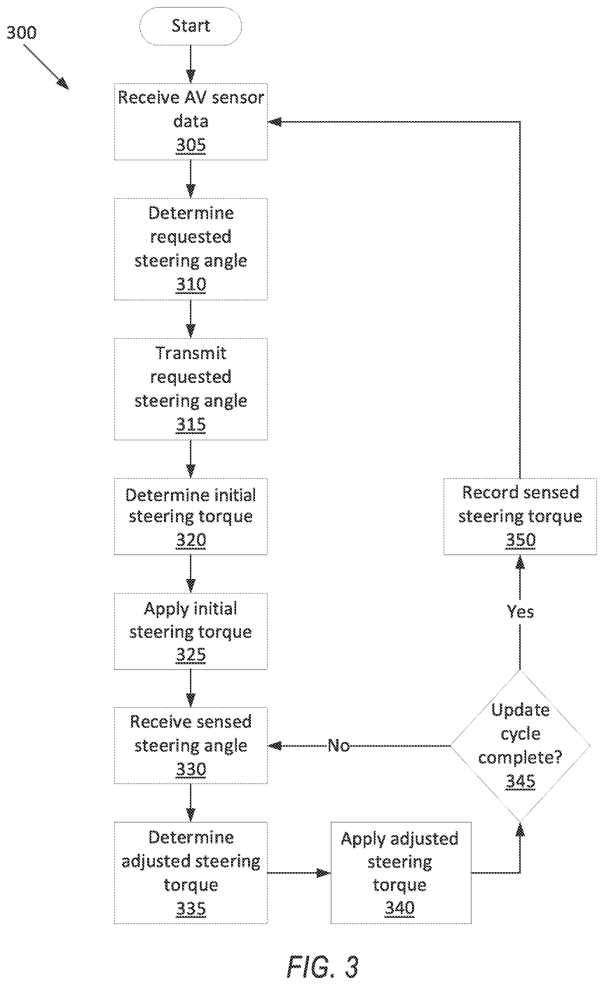

FIG. 3 is a process flow diagram illustrating an exemplary process 300 for steering the vehicle 32. The memory of the computer 30, in particular of the vehicle computer 34 and of the power-steering control module 48, stores executable instructions for performing the steps of the process 300. In general, in the process 300, the vehicle computer 34 requests a steering angle for the vehicle 32, and the power-steering control module 48 adjusts the steering torque with a feedback loop to achieve the steering angle. The steering angle is an angle between a direction that the road wheels 56 are turned and an axis defined relative to a body of the vehicle 32, e.g., a longitudinal centerline of the vehicle 32. For example, in an implementation, when the road wheels 56 are turned straight forward, the steering angle is zero; when the road wheels 56 are turned to the right, the steering angle has a positive value; and when the road wheels 56 are turned to the left, the steering angle has a negative value.

The process 300 begins in a block 305, in which the vehicle computer 34 receives data from the sensors 50.

Next, in a block 310, the vehicle computer 34 determines a requested steering angle. For the purposes of this disclosure, the “requested steering angle” is defined as a desired steering angle for the vehicle 32 as determined by the computer 30, e.g., the vehicle computer 34. The vehicle computer 34 determines the requested steering angle using path-planning and trajectory-planning algorithms, as are known, such as grid-based search, interval-based search, geometric algorithms, reward-based algorithms, artificial potential fields, sampling-based algorithms, etc.

Next, in a block 315, the vehicle computer 34 transmits the requested steering angle via the communications network 42 to the power-steering control module 48.

Next, in a block 320, the power-steering control module 48 determines an initial steering torque for the steering actuator 66. The power-steering control module 48 uses a known algorithm such as a proportional-integral-derivative (PID) controller for rate and position. The initial steering torque is based on the requested steering angle, as well as possibly road or environmental conditions such as surface (paved or gravel), grade, wind speed and direction, precipitation, etc. For example, in heavy wind, turning against a wind direction requires more torque than turning with the wind direction.

Next, in a block 325, the power-steering control module 48 instructs the steering actuator 66 to apply the initial steering torque.

Next, in a block 330, the power-steering control module 48 receives a sensed steering angle. For the purposes of this disclosure, the “sensed steering angle” is defined as the steering angle of the vehicle 32 as determined from the steering sensors 52, rather than commanded by the computer 30. The power-steering control module 48 determines the sensed steering angle based on the data from the steering sensors 52. The sensed steering angle may be a sensed position of a physical component of the steering system 40, e.g., the steering rack 60, the steering column 62, the steering actuator 66, etc.

Next, in a block 335, the power-steering control module 48 determines an adjusted steering torque. The adjusted steering torque is based on the immediately previous steering torque, which may be the initial steering torque from the block 320 if an adjusted steering torque has not yet been determined or may be the adjusted steering torque from the immediately previous iteration of this block 335, and the adjusted steering torque is also based on a difference between the requested steering angle and the sensed steering angle. If the sensed steering angle is below the requested steering angle, then the adjusted steering torque is increased compared to the immediately previous steering torque. If the sensed steering angle exceeds the requested steering angle, then the adjusted steering torque is decreased compared to the immediately previous steering torque.

Next, in a block 340, the power-steering control module 48 instructs the steering actuator 66 to apply the adjusted steering torque.

Next, in a decision block 345, the power-steering control module 48 determines whether the update cycle of the vehicle computer 34 is complete. For the purposes of this disclosure, the “update cycle” is defined as the time interval for one of the ECMs 44, 46, 48 or the vehicle computer 34 to generate new state variables such as the requested steering angle or adjusted steering torque. The update cycle of the vehicle computer 34 is longer than the update cycle of the power-steering control module 48, so the adjusted steering torque is regenerated multiple times in the block 335 for each time the requested steering angle is regenerated in the block 310. The power-steering control module 48 may use a timer to track the length of time since receiving the requested steering angle. If the timer has not yet reached the update cycle for the vehicle computer 34, the process 300 returns to the block 330 to readjust the steering torque.

If the timer has reached the update cycle for the vehicle computer 34, next, in a block 350, the power-steering control module 48 and/or the vehicle computer 34 stores the current value of the adjusted steering torque as a sensed steering torque. For the purposes of this disclosure, the “sensed steering torque” is defined as the steering torque actually applied by the steering actuator 66 to achieve the requested steering angle, rather than the initial steering torque expected to achieve the requested steering angle. After the block 350, the process 300 returns to the block 305 to restart the update cycle of the vehicle computer 34.

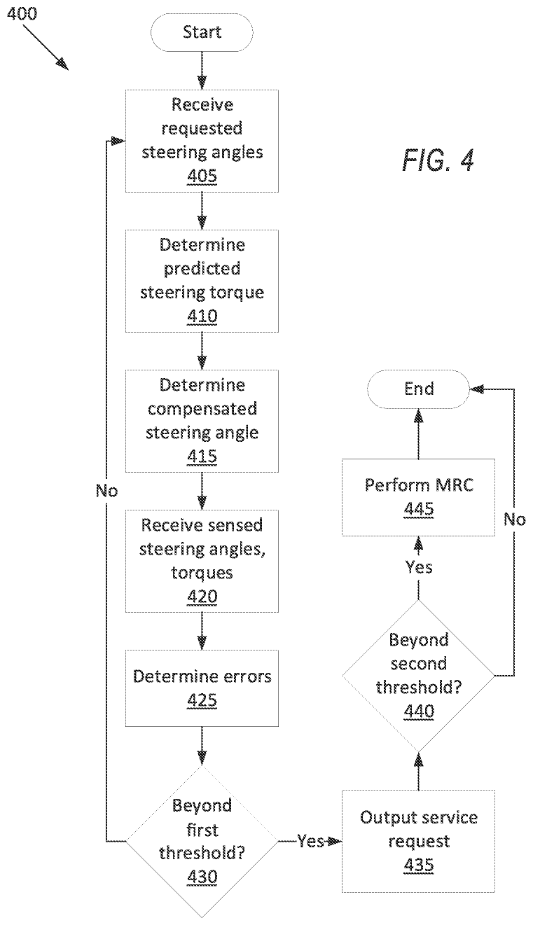

FIG. 4 is a process flow diagram illustrating an exemplary process 400 for addressing deviations in steering the vehicle 32. The memory of the computer 30 stores executable instructions for performing the steps of the process 400. In general, in the process 400, the computer 30 checks for deviations between a predicted value and the sensed steering angle or the sensed steering torque, e.g., a deviation between the requested steering angle and the sensed steering angle, a deviation between a predicted steering torque and the sensed steering torque, or a thrust angle between a compensated steering angle and the sensed steering angle. The predicted steering torque, thrust angle, and compensated steering torque are described in more detail below. If one of the deviations exceeds a first threshold, the computer 30 outputs a service request, and if one of the deviations exceeds a second threshold, the computer 30 performs a minimal risk condition, as described below.

The process 400 begins in a block 405, in which the computer 30 receives a sequence of requested steering angles. The sequence of requested steering angles may include the requested steering angle for each update cycle of the vehicle computer 34 for an interval of time. The interval of time may be chosen to be sufficiently long to determine the predicted steering torque, the compensated steering angle, and the frequency and amplitude of the requested and sensed steering angles, while also being short enough to be computationally feasible, i.e., that the computations can be completed in time. Each requested steering angle in the sequence of requested steering angles is paired with a corresponding time value, i.e., θ_{req_seq}={(t₁, θ_{req1}), (t₂, θ_{req2}), (t₃, θ_{req3}), . . . (tₙ, θ_{req_n})}, in which θ_{req_seq} is the sequence of requested steering angles, tᵢ is the ith time value, θ_{req_i} is the ith requested steering angle, and n is the number of requested steering angles.

Next, in a block 410, the computer 30 calculates the predicted steering torque. The predicted steering torque is an average over an interval of driving of the individual predicted steering torques at each time value, i.e., T̅_{pred}=(T_{pred1}+T_{pred2}+T_{pred3}+ . . . +T_{pred_n})/n, in which T̅_{pred} is the overall predicted steering torque, T_{pred_i} is the ith individual predicted steering torque, and n is the number of individual requested steering torques. The individual predicted steering torques are based on a position of the vehicle 32 over the interval. The individual predicted steering torques may also be based on road or environmental conditions over the interval. The interval may be the same as the interval of time. The individual predicted steering torques may be calculated in the same manner as the initial steering torque as described above with respect to the block 320.

Next, in a block 415, the computer 30 determines the compensated steering angle based on the wheels speeds of the vehicle 32. The computer 30 receives the wheels speeds from the steering sensors 52, e.g., wheel-speed sensors. For the purposes of this disclosure, the “compensated steering angle” is defined as a heading of the vehicle 32 as determined from the wheel speeds. The compensated steering angle is calculated from the wheels speeds of the road wheels 56, i.e., θ_{comp}=f(ω₁, ω₂, ω₃, ω₄), in which θ_{comp} is the compensated steering angle and wi is the rotational speed of the ith road wheel 56.

Next, in a block 420, the computer 30 receives the sensed steering angles and steering torques. The sensed steering angles may be a sequence of sensed steering angles over the same interval of time as the requested steering angles from the block 405. The sensed steering angles may be received from the steering sensors 52 or determined data received from the steering sensors 52. Each sensed steering angle in the sequence of sensed steering angles is paired with a corresponding time value, i.e., θ_{sen_seq}={(t₁, θₛₑₙ₁), (t₂, θₛₑₙ₂), (t₃, θₛₑₙ₃), . . . (tₙ, θ_{sen_n})}, in which θ_{sen_seq} is the sequence of sensed steering angles, tᵢ is the ith time value, θ_{sen_i} is the ith sensed steering angle, and n is the number of sensed steering angles. The sensed steering torques may be a sequence of sensed steering torques over the interval of time. The sensed steering torques may be looked up from the memory of the computer 30 as stored in the block 345. Each sensed steering torque in the sequence of sensed steering torques is paired with a corresponding time value, i.e., T_{sen_seq}={(t₁, Tₛₑₙ₁), (t₂, Tₛₑₙ₂), (t₃, Tₛₑₙ₃), . . . (tₙ, T_{sen_n})}, in which T_{sen_seq} is the sequence of sensed steering torques, tᵢ is the ith time value, T_{sen_i} is the ith sensed steering torque, and n is the number of sensed steering torques.

Next, in a block 425, the computer 30 determines a plurality of deviations between the predicted values and the sensed steering angles or the sensed steering torques. For the purposes of this disclosure, an “deviation” means a comparison between two values or sequences of values that are theoretically close, i.e., close in a properly functioning system, but that may deviate if a malfunction occurs in the system. A first deviation is a difference between the requested steering angle and the sensed steering angle. For example, the first deviation may be determined by subtracting the most recent sensed steering angle and requested steering angle, i.e., E₁=θ_{sen_n}−θ_{req_n}, in which E₁ is the first deviation, θ_{sen_n} is the last sensed steering angle in the sequence of sensed steering angles, and θ_{req_n} is the last requested steering angle in the sequence of requested steering angles

Continuing with the block 425, a second deviation is a delay between the requested steering angle and the sensed steering angle. For the purposes of this disclosure, a “delay” is a time offset between two curves each representing a sequence of values over time. For example, the second deviation may be determined by (1) selecting the requested steering angle with the largest change from the previous requested steering angle from among the sequence of requested steering angles, i.e., θ_{req_j} such that j=maxᵢ(θ_{req_i}−θ_{req_i-1}), (2) selecting the sensed steering angle equal to the selected requested steering angle, i.e., θ_{sen_k}=θ_{req_j}, and (3) subtracting the time values paired with the selected requested steering angle and sensed steering angle, i.e., E₂=tₖ−tⱼ.

Continuing with the block 425, a third deviation is a difference between a frequency of the requested steering angle and a frequency of the sensed steering angle. For example, the third deviation may be determined by (1) subtracting a curve of expected steering angles based on the path of the vehicle 32 over the interval from both the sequence of requested steering angles and the sequence of sensed steering angles, i.e., θₛₑₙ^{remainder}=θₛₑₙ(t)−θ_{sen_exp}(t) and θ_{req}^{remainder}=θ_{req}(t)−θ_{req_exp}(t), (2) fitting a periodic function to the remainder sequence of requested steering angles and to the remainder sequence of sensed steering angles, e.g., Aₛₑₙ*sin(2πfₛₑₙt) and A_{req}*sin(2πf_{req}t), and (3) subtracting the two frequencies from the two fitted curves, i.e., E₃=fₛₑₙ−f_{req}. Alternatively to subtracting the curve of expected steering angles, the computer 30 may wait until the vehicle 32 is driving along a straight road and use the sequences of steering angles instead of the remainder sequences.

Continuing with the block 425, a fourth deviation is a difference between an amplitude of the requested steering angle and an amplitude of the sensed steering angle. For example, the fourth deviation may be determined by (1) subtracting a curve of expected steering angles based on an expected path of the vehicle 32 from both the sequence of requested steering angles and the sequence of sensed steering angles, i.e., θₛₑₙ^{remainder}=θₛₑₙ(t)−θ_{sen_exp}(t) and θ_{req}^{remainder}=θ_{req}(t)−θ_{req_exp}(t), (2) fitting a periodic function to the remainder sequence of requested steering angles and to the remainder sequence of sensed steering angles, e.g., Aₛₑₙ*sin(2πfₛₑₙt) and A_{req}*sin(2πf_{req}t), and (3) subtracting the two amplitudes from the two fitted curves, i.e., E₄=Aₛₑₙ−A_{req}. Alternatively to subtracting the curve of expected steering angles, the computer 30 may wait until the vehicle 32 is driving along a straight road and use the sequences of steering angles instead of the remainder sequences.

Continuing with the block 425, a fifth deviation is a difference between the predicted steering torque and the sensed steering torque. For example, the fifth deviation may be determined by (1) calculating the mean of the sequence of sensed steering torques, i.e., T̅ₛₑₙ=(Tₛₑₙ₁+Tₛₑₙ₂+Tₛₑₙ₃+ . . . +T_{sen_n})/n, and (2) subtracting the mean of the sequence of sensed steering angles and the predicted steering torque, i.e., E_{S}=T̅ₛₑₙ−T̅_{pred}.

Continuing with the block 425, a sixth deviation is a thrust angle of the vehicle 32. For the purposes of this disclosure, the “thrust angle” is defined as a horizontal direction of the front road wheels 56 (when the steering system 40 is centered) or rear road wheels 56 relative to a centerline of the vehicle 32. For example, the sixth deviation may be determined by subtracting the compensated steering angle and the sensed steering angle, i.e., E₆=θ_{sen_n}−θ_{comp_n}.

Next, in a decision block 430, the computer 30 determines whether any of the deviations E₁, . . . E₆ exceed a first threshold corresponding to that deviation. For example, the computer 30 may determine if the absolute values of any of the deviations are greater than the first threshold corresponding to that deviation. The first thresholds are preset values stored in the memory of the computer 30. The first thresholds for the first through sixth deviations may be determined by experimental simulation and then experimentation, i.e., causing known failure modes to find the values at which performance degradation is noticeable to an occupant or interferes with operation of the vehicle 32. If none of the deviations are beyond the corresponding first threshold, the process 400 returns to the block 405 to continue monitoring the deviations.

In response to at least one of the deviations exceeding the corresponding first threshold, next, in a block 435, the computer 30 outputs a service request through the user interface 54. For example, the user interface 54 may play a beeping sound and illuminate a “check alignment” or “check steering” light. Alternatively or additionally, the computer 30 may output the service request by transmitting the service request to a remote server, e.g., associated with an owner of the vehicle 32. In addition, the computer 30 may set an error code. Each of the first through sixth deviations may have a unique error code for exceeding the corresponding first threshold. The error code may be stored in the memory of the computer and may be outputted through the on-board diagnostic connector (OBD-II) when accessed by, e.g., a service technician.

Next, in a decision block 440, the computer 30 determines whether any of the deviations determined in the block 425 exceed a second threshold corresponding to that deviation. For example, the computer 30 may determine if the absolute values of any of the deviations are greater than the second threshold corresponding to that deviation. Each second threshold is greater than the corresponding first threshold. The second thresholds are preset values stored in the memory of the computer 30. The second thresholds for the first through sixth deviations may be determined by experimental simulation and then experimentation in which known failure modes are caused and then used to find the values at which the vehicle 32 is inoperable. If none of the deviations are beyond the corresponding second threshold, the process 400 ends.

In response to at least one of the deviations exceeding the corresponding second threshold, next, in a block 445, the computer 30 performs a minimal risk condition. For purposes of this disclosure, that term has the meaning accorded by the National Highway Traffic Safety Administration (NHTSA) and the Society of Automotive Engineers (SAE): “‘Minimal risk condition’ means low-risk operating condition that an automated driving system automatically resorts to either when a system fails or when the human driver fails to respond appropriately to a request to take over the dynamic driving task.” (U.S. Dept. of Transportation & NHTSA, Automated Driving Systems 2.0: A Vision for Safety, at 26 (citing SAE International J3016, International Taxonomy and Definitions for Terms Related to Driving Automation Systems for On-Road Motor Vehicles (J3016:September 2016)).) For example, the minimal risk condition may be initiating a handover to the human driver or autonomously driving the vehicle 32 to a halt at a roadside, i.e., stopping the vehicle 32 outside active lanes of traffic. The computer 30 stores different types of minimal risk conditions paired with triggers, i.e., events that the computer 30 responds to with the respective minimal risk condition.

| Trigger | Minimal Risk Condition |
|---|---|
| Low tire pressure | Pull over at next designated stopping location |
| Tire blowout | Immediately drive to halt at roadside |
| Exceed second threshold | Immediately drive to halt at roadside |
| Impact imminent | Immediate maximum braking |
| . | . |
| . | . |
| . | . |

The minimal risk condition for a particular trigger may be chosen by balancing the risk of the trigger with the risk from performing the minimal risk condition. The vehicle computer 34 may perform the minimal risk condition by using known autonomous-operation algorithms. After the block 445, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The disclosure has been described in an illustrative manner, and it is to be understood that the terminology which has been used is intended to be in the nature of words of description rather than of limitation. Use of “in response to” and “upon determining” indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory storing processor-executable instructions, wherein the processor is programmed to:
determine a deviation between a predicted value and one of a sensed steering angle and a sensed steering torque of a vehicle;
output a service request in response to the deviation exceeding a first threshold; and
perform a minimal risk condition in response to the deviation exceeding a second threshold.

2. The computer of claim 1, wherein the predicted value is a requested steering angle.

3. The computer of claim 2, wherein the deviation is one of a difference between the requested steering angle and the sensed steering angle, a delay between the requested steering angle and the sensed steering angle, a difference between a frequency of the requested steering angle and of the sensed steering angle, and a difference between an amplitude of the requested steering angle and of the sensed steering angle.

4. The computer of claim 3, wherein the sensed steering angle is a sensed position of a physical component of a steering system of the vehicle.

5. The computer of claim 3, wherein the processor is further programmed to instruct a steering system to turn the vehicle by the requested steering angle.

6. The computer of claim 1, wherein the predicted value is a compensated steering angle, and the deviation is a thrust angle.

7. The computer of claim 6, wherein the processor is further programmed to determine the compensated steering angle based on wheel speeds of the vehicle.

8. The computer of claim 1, wherein the predicted value is a predicted steering torque, and the deviation is a difference between the predicted steering torque and the sensed steering torque.

9. The computer of claim 8, wherein the processor is further programmed to calculate the predicted steering torque as an average for an interval of driving based on a position of the vehicle over the interval.

10. The computer of claim 9, wherein calculating the predicted steering torque is also based on road conditions over the interval.

11. A method comprising:
determining a deviation between a predicted value and one of a sensed steering angle and a sensed steering torque of a vehicle;
outputting a service request in response to the deviation exceeding a first threshold; and
performing a minimal risk condition in response to the deviation exceeding a second threshold.

12. The method of claim 11, wherein the predicted value is a requested steering angle.

13. The method of claim 12, wherein the deviation is one of a difference between the requested steering angle and the sensed steering angle, a delay between the requested steering angle and the sensed steering angle, a difference between a frequency of the requested steering angle and of the sensed steering angle, and a difference between an amplitude of the requested steering angle and of the sensed steering angle.

14. The method of claim 13, wherein the sensed steering angle is a sensed position of a physical component of a steering system of the vehicle.

15. The method of claim 13, further comprising instructing a steering system to turn the vehicle by the requested steering angle.

16. The method of claim 11, wherein the predicted value is a compensated steering angle, and the deviation is a thrust angle.

17. The method of claim 16, further comprising determining the compensated steering angle based on wheel speeds of the vehicle.

18. The method of claim 11, wherein the predicted value is a predicted steering torque, and the deviation is a difference between the predicted steering torque and the sensed steering torque.

19. The method of claim 18, further comprising calculating the predicted steering torque as an average for an interval of driving based on a position of the vehicle over the interval.

20. The method of claim 19, wherein calculating the predicted steering torque is also based on road conditions over the interval.
